(19) United States
(12) Patent Application Publication
(10) Pub. No.: US 2012/0031370 A1
(43) Pub. Date: Feb. 9, 2012

(54) CONTROL OF THE VANES OF A VANE CELL MACHINE

(76) Inventor: Eggert Guenther, Bad Doberan (DE)

(21) Appl. No.: 13/264,130

(22) PCT Filed: May 4, 2010
(86) PCT No.: PCT/EP2010/056021

§ 371 Date: Oct. 12, 2011

(30) Foreign Application Priority Data
Apr. 14, 2009 (DE) 10 2009 017 332.3

(51) Int. Cl. F02B 53/00

(52) U.S. Cl. 123/243

(57) ABSTRACT

The invention relates to the control of the vanes of vane machines by means of a disk-shaped control link arranged inside a divided rotor, which control link is connected to the housing of the machine by means of a central axle in alignment with the rotor shaft and takes on the guidance of the vanes when the rotor rotates relative to the housing track.

### BACKGROUND OF THE INVENTION

This invention relates to control of the vanes of vane cell engines to reduce the friction between the vanes and the housing runway.

Because of their simple construction, vane cell engines are used as compressors and pumps as well as expanders and hydro-motors. Especially when used with gaseous media, vane cell engines with higher revolutions per minute can be operated so that due to the acting centrifugal forces, the vanes can be made to press close to the housing runway without additional radial outward-acting pressure springs. Thus the housing runway gets the task of guiding the vanes along the runway contour. To fulfill this function, the centrifugal forces have at all times to be larger than the counter-acting forces because of the pressure of the medium on to the vane frontal area in order to obtain a complete sealing of the rotating working vanes. The pressing vanes cause considerable friction. By injecting a liquid lubricant this friction can be reduced.

Another way to reduce the friction is to steer the vanes instead of by the runway by means of a guidance ring mounted at the lateral wall of the vane cell engine. A corresponding proposal is included in the patent document DE 10 2006 028 807 A1 for a pressure cell engine. An implementation into practice has not become known. On the one hand, laterally arranged guidance rings do offer the possibility of reducing friction;, at the same time they, however, cause the generation of further leakage windows for a medium transition between the cells as well as into the area of the rotor axis.

### SUMMARY OF THE INVENTION

The present invention is based on the task to allow movement of the vanes by means of guidance along a guidance slot link inside the rotor and thus to obtain a reduction of friction at the vane tips as well as simultaneously preventing internal media leakages between the cells.

In a rotor divided at a right angle to the rotating axis, as has been described in patent document DE 10 2006 057 003 A1, according to the present invention a control link is mounted at a housing-mounted axle that extends into the rotor that guides the vanes in radial direction against the housing runway. One of the features of the invention is that for guiding the movement of the vanes, the foot area of the vane is equipped with guide elements such as rolls that run in the control link, and that the guide elements are connected by springs to the vanes in such a way that they are pressed by spring force against the control link guide path with the spring force directed opposite to the acting centrifugal forces. (An option is to augment adherence of the guide elements to the control link guide path by magnetic attraction between the guide elements and the control link guide path.) According to the invention, the spring forces are tuned to the centrifugal forces in such a way that when the engine is started the vanes barely touch the housing runway thus granting an easy starting and that afterwards the guide elements or rolls will always run along the control link when the rotor has reached a pre-determined operation speed and a statically determined system of forces has formed.

The invention is described by means an embodiment.

### BRIEF DESCRIPTION OF THE DRAWINGS

FIG. 1 is an exploded perspective view of an embodiment of the invention;

FIG. 2 is another exploded perspective view of said embodiment of the invention;

FIG. 3 is a front perspective exploded view of vane parts with expanding spring and bending spring;

FIG. 4 is a rear perspective exploded view of vane parts with expanding spring and bending spring;

FIG. 5 is a perspective view of vane parts assembled;

FIG. 6 is a perspective view of vane parts with control link disc;

FIG. 7 is a section view through the rotor with vanes and control link disc; and

FIG. 8 is a schematic representation of the geometry of the guiding runway on the control link disc.

### DETAILED DESCRIPTION OF THE INVENTION

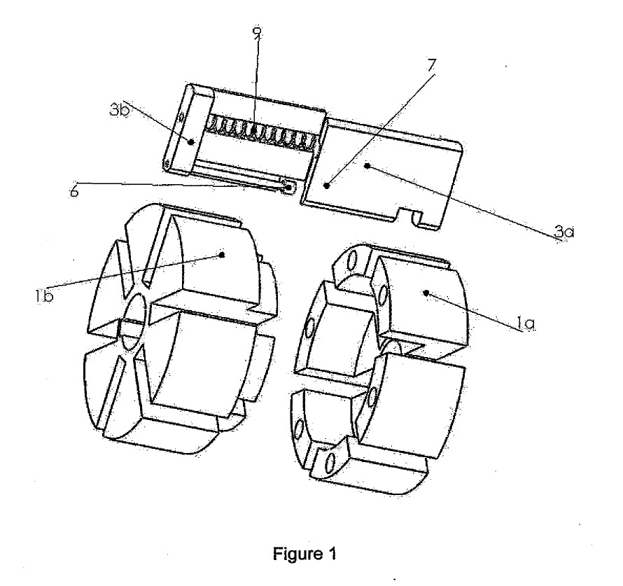

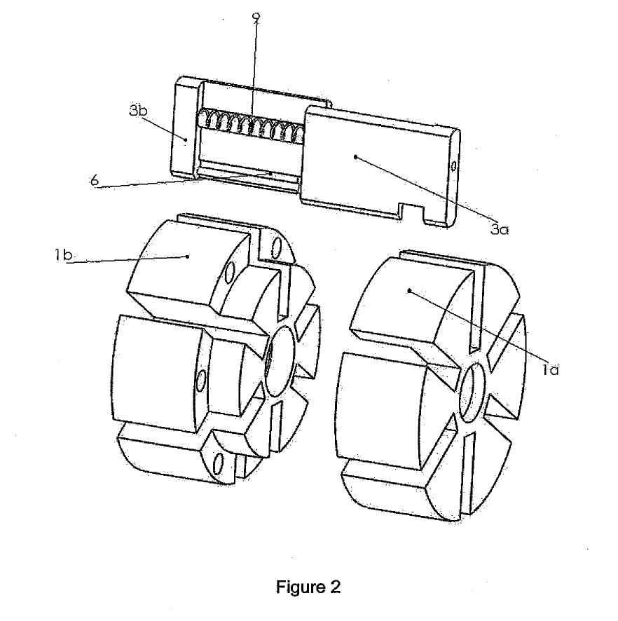

The operation principle of a divided rotor is shown in FIGS. 1 and 2. Both rotor parts are pressed apart by internal expansion springs, not shown here, so that rotation of the rotor parts relative to each other cannot take place. In the guiding grooves of the rotor, the cell vanes are movably arranged. Each vane consists of the vane parts 3a and 3b one of which covers the other and which are urged away from each other by expansion springs 9 in milled-out grooves 11a and 11b in such a way that they, together with the rotor parts, are flush with the housing sides and seal the operating areas against each other.

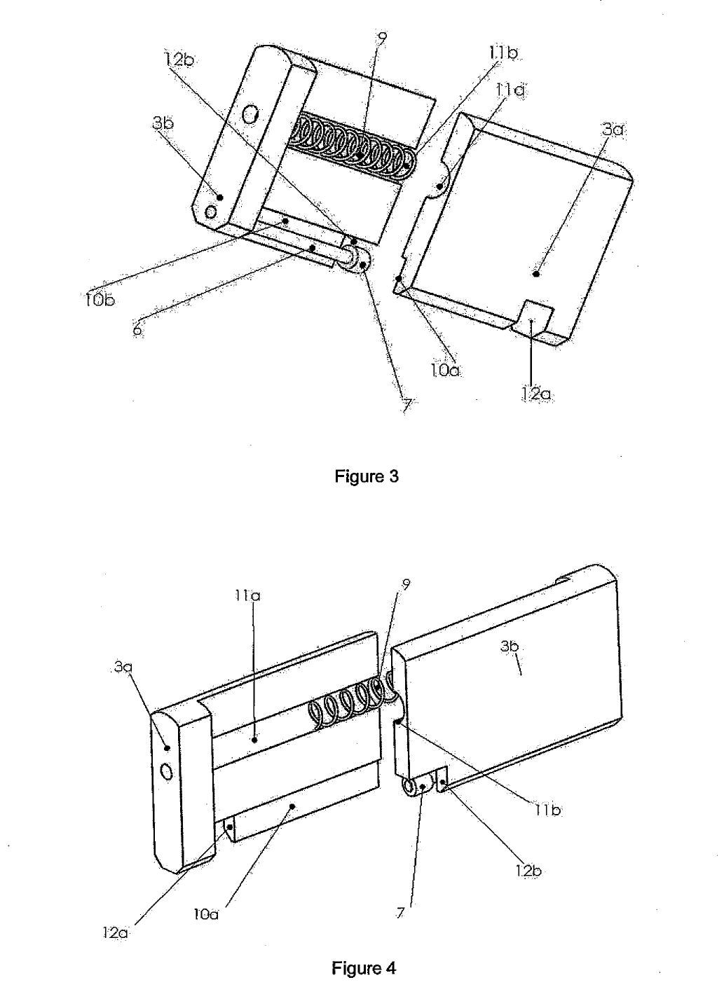

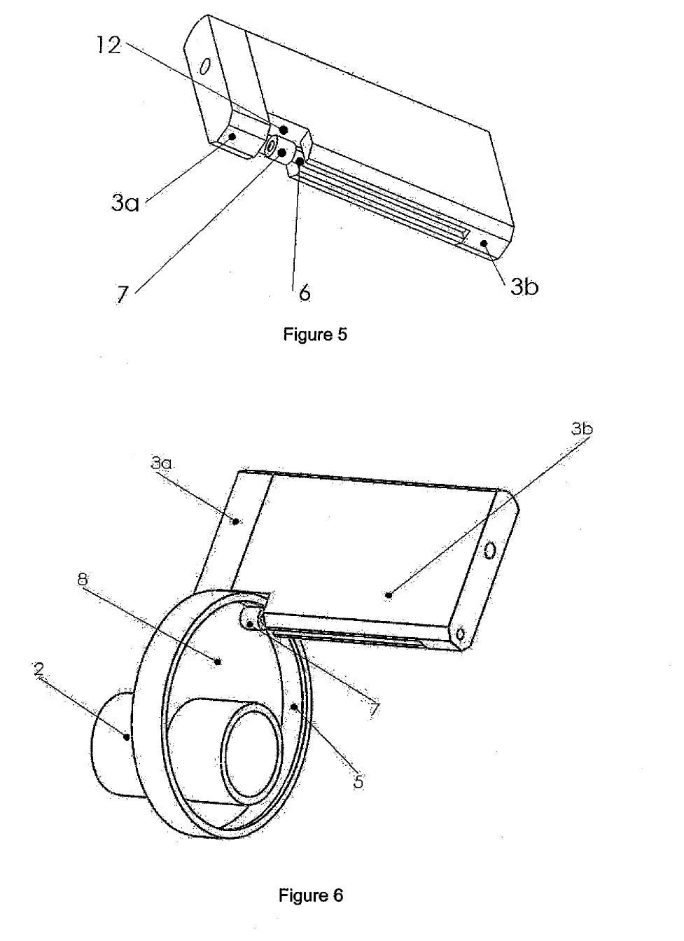

The vanes have at their foot area, adjacent to the rotor center, milled-out grooves 10a and 10b, that together form a housing for bending spring 6. Bending spring 6 is fixed to vane part 3b. At the end of the bending spring 6, roll 7 is attached in such a way that it can run in the control link disc 8. Furthermore the milled-out grooves 12a and 12b are placed in the vane parts so that when the vane is assembled, the opening 12 results, for receiving the control link disc 8, FIG. 3, FIG. 4, FIG. 5 and FIG. 6.

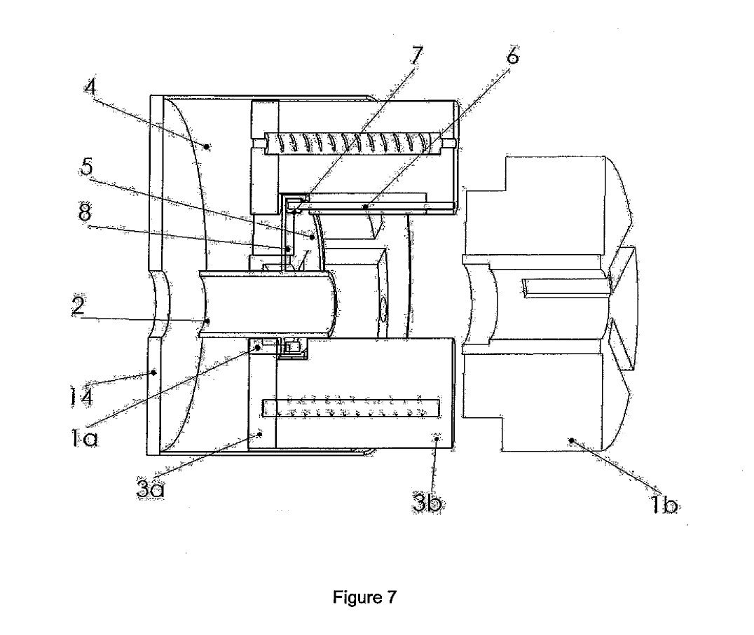

The assembled rotor is shown in FIG. 7, wherein rotor part lb is connected to the rotor axle, not shown. Rotor part 1a is carried along by rotor part 1b via the vanes 3.

In between rotor parts 1a and 1b, control link disc 8 is mounted on the hollow axle 2.

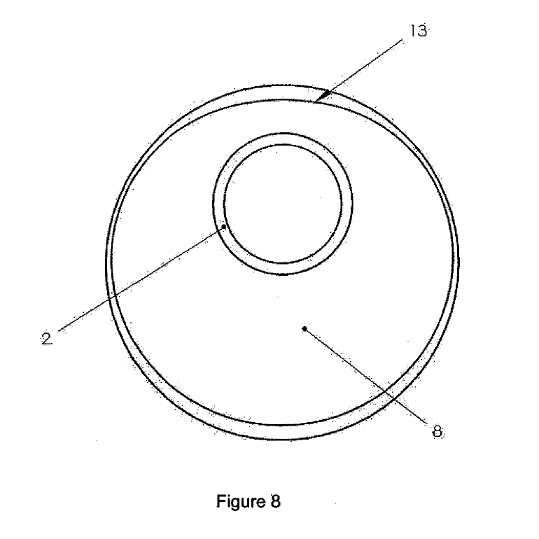

The hollow axle 2 is rigidly connected to the housing 4 via lateral cover 14 and thus provides a housing-mounted control link guidance for rolls 7 running along the guidance runway 5. In the example shown, the control link contour is a single arc trochoid 13, offset with respect to the rotor axis by the eccentricity of the vane cell engine, see FIG. 8. The mathematical formation law of this trochoid is T(φ) =R−exz*cos (φ), with the eccentricity, exz′ of rotor 1 with regard to the housing 4, with the radius R and the angle of rotation φ. Other contours are possible if the control link obeys radial closing distances to the housing runway. Through the hollow axis 2, the rotor shaft can be taken to a bearing situated next to the side/lateral cover. In a particular, specific embodiment, the control disc is situated eccentrically on the control link disc axle with the rotor, of course, being situated eccentrically in the housing, and the respective eccentricities are in opposite directions.

By construction, vane 3 is arranged with the bending spring 6 and the roll 7 so that at low rotor rotation speeds, e.g. while starting the engine, roll 7 runs from the inside against the guidance runway 5, but there is not yet any contact between vane tip and housing, allowing for a smooth starting. When an operation rotation speed, determined by the design, has been reached, the centrifugal forces cause a pressing of the vanes on to the housing runway against to the spring force of bending spring 6. Thus bending spring 6 secures that roll 7 has at all times contact to guidance runway 5, at the same time it also draws the vanes kinematically exact on to the determined course of motion of control link disc 8. In this way, a statically determined system of forces develops itself automatically. Considering the fact that the sealing system can only act dynamically in the housing, the construction parts rotor parts 1a, 1b, vane parts 3a, 3b and the axial arrangement of control link disc 8 are designed according to the invention with offset divided and working grooves, thus forming an effective labyrinth packing that prevents any media from leaking through.

1.-8. (canceled)

9. Method for controlling vanes of a vane cell engine comprising a housing containing a plural-part rotor for mounting on a rotor shaft and vanes received by the rotor, the method comprising
providing a control disc on a control disc axle fixed to an end wall of the housing and aligned with the rotor shaft,
guiding the vanes by means of the control disc during rotation of the rotor,
applying a spring force to the vanes which acts against centrifugal force acting on the vanes during rotation of the rotor, and
predetermining the spring force so that tips of the vanes do not contact the housing until rate of revolution of the rotor attains a predetermined value.

10. The method of claim 9, wherein the control disc comprises a circumferential guidance runway for controlling radial position of the vanes and the method further comprises providing springs for urging the tips of the vanes radially outwardly.

11. The method of claim 10, further comprising providing rolls on the vane, the rolls engaging the guidance runway.

12. The method of any one of claims 9 to 11, further comprising situating the rotor eccentrically with respect to the housing and situating the control disc eccentrically on the control disc axle, the respective eccentricities of the rotor and of the control disc being in opposite directions.

13. The method of claim 10 or 11, further comprising providing the housing with a circular runway for the vanes and configuring the guidance runway of the control disc as a single arc trochoid.

14. Apparatus for controlling vanes of a vane cell engine, comprising a plural-part rotor for mounting on a rotor shaft, vanes bridging the plural parts of the rotor, a control disc mounted on a control disc axle aligned with the rotor shaft and situated within the rotor, the rotor disc having a circumferential runway perpendicular to a plane of the control disc, vanes radially displaceably received by the rotor, and at a radially inward end portion of each vane a spring-mounted guiding element engaging the circumferential runway and thereby affecting radial displacement of the vane, wherein each of the springs applies a force in a direction opposite centrifugal force occurring upon rotation of the rotor.

15. Apparatus according to claim 14, wherein each of the guiding elements comprises a roll.

16. Apparatus according to claim 14, wherein the circumferential runway is a single arc trochoid.

17. Apparatus according to claim 14, wherein the guiding elements are magnetically attracted to the circumferential runway.
